(19) United States
(12) Patent Application Publication
(10) Pub. No.: US 2014/0040908 A1
(43) Pub. Date: Feb. 6, 2014

(54) RESOURCE ASSIGNMENT IN A HYBRID SYSTEM

(71) Applicants: Munehiro Doi, Yokohama-shi (JP); Kumiko Maeda, Tokyo (JP); Masana Murase, Tokyo (JP)

(72) Inventors: Munehiro Doi, Yokohama-shi (JP); Kumiko Maeda, Tokyo (JP); Masana Murase, Tokyo (JP)

(73) Assignee: INTERNATIONAL BUSINESS MACHINES CORPORATION, Armonk, NY (US)

(21) Appl. No.: 13/569,558

(22) Filed: Aug. 8, 2012

Related U.S. Application Data
(63) Continuation of application No. 13/563,963, filed on Aug. 1, 2012.

(51) Int. Cl. G06F 9/50

(52) U.S. Cl. 718/104

(57) ABSTRACT

A system processing an application in a hybrid system includes a database comprising a plurality of libraries, each library comprising sub-program components, wherein two or more of the components are combined by an end user into a stream flow defining an application. The system also includes a plurality of resources configured to process the stream flow, architecture of at least one of the plurality of resources being different from architecture of another of the plurality of resources. The system also includes a compiler configured to generate a resource assignment assigning the plurality of resources to the two or more of the components in the stream flow, at least two of the two or more of the components in the stream flow sharing at least one of the plurality of resources according to the resource assignment.

### CROSS REFERENCE TO RELATED APPLICATION

This application is a continuation of U.S. application Ser. No. 13/563,963, filed Aug. 1, 2012, the disclosure of which is incorporated by reference herein in its entirety.

### BACKGROUND

The present invention relates to hybrid systems, and more specifically, to resource scheduling in hybrid systems.

Hybrid systems include multiple parallel processors with different architectures that are connected by a plurality of networks or buses. The diverse architecture within hybrid systems, which includes different types of processors, network topologies, etc., presents a challenge in writing applications that make efficient use of the resources of the hybrid system. Further, while application program code and resource mapping specific to a given hybrid system can be written, it generally requires expertise and knowledge about the specific hybrid system that most end users do not possess. Thus, a system and method of resource scheduling that takes into consideration the resources of the hybrid system would be appreciated in the computing industry.

### SUMMARY

According to one embodiment, a system for processing an application in a hybrid system includes a database comprising a plurality of libraries, each library comprising sub-program components, wherein two or more of the components are combined by an end user into a stream flow defining an application; a plurality of resources configured to process the stream flow, architecture of at least one of the plurality of resources being different from architecture of another of the plurality of resources; and a compiler configured to generate a resource assignment assigning the plurality of resources to the two or more of the components in the stream flow, at least two of the two or more of the components in the stream flow sharing at least one of the plurality of resources according to the resource assignment.

According to another embodiment, a computer-implemented method of processing an application in a hybrid system comprising a plurality of resources, architecture of at least one of the plurality of resources being different from architecture of another of the plurality of resources, comprises storing libraries of sub-program components, two or more of the components being combined by an end user to generate the application as a stream flow; and a compiler generating a resource assignment assigning the plurality of resources to process the two or more of the components in the stream flow, at least two of the two or more of the components in the stream flow sharing at least one of the plurality of resources according to the resource assignment.

According to yet another embodiment, a non-transitory computer program product for processing an application in a hybrid system comprising a plurality of resources, architecture of at least one of the plurality of resources being different from architecture of another of the plurality of resources, comprises a storage medium including computer-readable program code which, when executed by a processor, causes the processor to implement a method. The method comprises generating an initial resource assignment assigning the plurality of resources to process each of two or more components in the stream flow defining the application; and when a number of resources in the initial resource assignment exceeds a number of the plurality of resources available in the hybrid system, generating a final resource assignment, from the initial resource assignment, assigning the plurality of resources to process the two or more of the components in the stream flow, at least two of the two or more of the components in the stream flow sharing at least one of the plurality of resources according to the final resource assignment.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a hybrid system according to an embodiment;

FIG. 2 is a functional block diagram according to an embodiment;

FIG. 3 is a flow diagram of a resource assignment process according to an embodiment;

FIGS. 4-27 illustrate blocks of the flow diagram shown at FIG. 3 for an exemplary stream diagram, in which:

FIG. 4 depicts an initial resource assignment resulting from block 310 of the flow diagram shown at FIG. 3,

FIG. 5 depicts another resource assignment based on the resource assignment shown at FIG. 4 resulting from block 315 of the flow diagram shown at FIG. 3,

FIG. 6 depicts a resource assignment resulting from block 320 of the flow diagram shown at FIG. 3,

FIG. 7 depicts a resource assignment resulting from block 335 of the flow diagram shown at FIG. 3,

FIG. 8 depicts a resource assignment resulting from block 340 of the flow diagram shown at FIG. 3,

FIG. 9 depicts a resource assignment resulting from block 345 of the flow diagram shown at FIG. 3,

FIG. 10 depicts a resource assignment resulting from block 365 of the flow diagram shown at FIG. 3,

FIG. 11 depicts the resource assignments resulting from a second iteration of blocks 330 and 335 of the flow diagram shown at FIG. 3,

FIG. 12 depicts the resource assignments resulting from a second iteration of blocks 340 through 370 of the flow diagram shown at FIG. 3,

FIG. 13 depicts the resource assignments resulting from a third iteration of blocks 330 and 335 of the flow diagram shown at FIG. 3,

FIG. 14 depicts the resource assignments resulting from a third iteration of blocks 340 through 370 of the flow diagram shown at FIG. 3,

FIG. 15 depicts the resource assignments resulting from a fourth iteration of blocks 330 and 335 of the flow diagram shown at FIG. 3,

FIG. 16 depicts the resource assignments resulting from a fourth iteration of blocks 340 through 370 of the flow diagram shown at FIG. 3,

FIG. 17 depicts the resource assignments resulting from a fifth iteration of blocks 330 and 335 of the flow diagram shown at FIG. 3,

FIG. 18 depicts the resource assignments resulting from a firth iteration of blocks 340 through 370 of the flow diagram shown at FIG. 3,

FIG. 19 depicts the resource assignments resulting from a sixth iteration of blocks 330 and 335 of the flow diagram shown at FIG. 3,

FIG. 20 depicts the resource assignments resulting from a sixth iteration of blocks 340 through 370 of the flow diagram shown at FIG. 3,

FIG. 21 depicts the resource assignments resulting from a seventh iteration of blocks 330 and 335 of the flow diagram shown at FIG. 3,

FIG. 22 depicts the resource assignments resulting from a seventh iteration of blocks 340 through 370 of the flow diagram shown at FIG. 3,

FIG. 23 depicts the resource assignments resulting from an eighth iteration of blocks 330 and 335 of the flow diagram shown at FIG. 3,

FIG. 24 depicts the resource assignments resulting from an eighth iteration of blocks 340 through 370 of the flow diagram shown at FIG. 3,

FIG. 25 depicts the resource assignments resulting from a ninth iteration of blocks 330 and 335 of the flow diagram shown at FIG. 3,

FIG. 26 depicts the resource assignments resulting from a ninth iteration of blocks 340 through 370 of the flow diagram shown at FIG. 3,

FIG. 27 depicts the resource assignments resulting from a tenth and final iteration of blocks 330 and 335 of the flow diagram shown at FIG. 3;

FIG. 28 illustrates component merging according to an embodiment;

FIG. 29 illustrates a process according to another embodiment; and

FIG. 30 illustrates the exemplary stream graph and available resources used in FIGS. 4-27.

### DETAILED DESCRIPTION

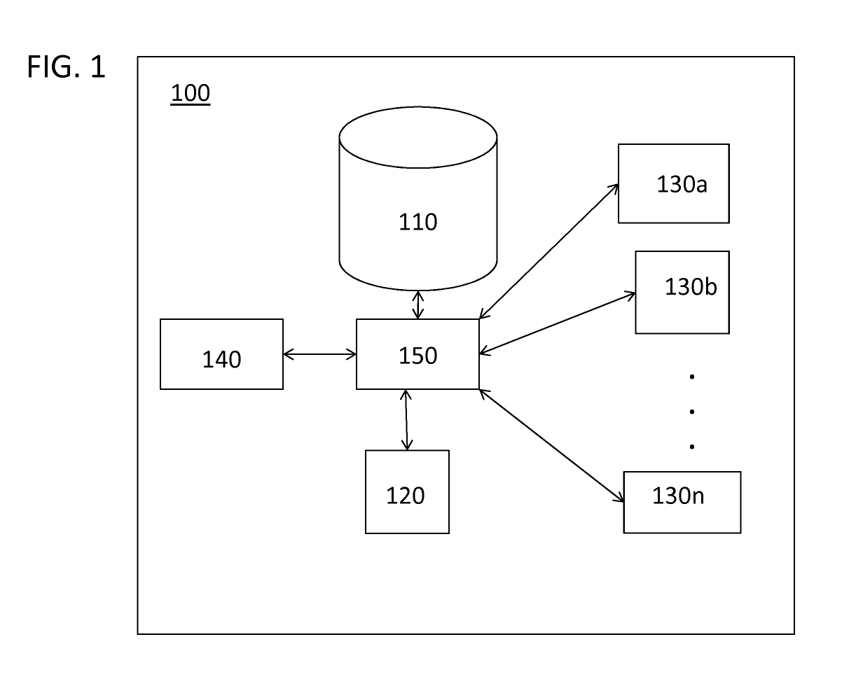

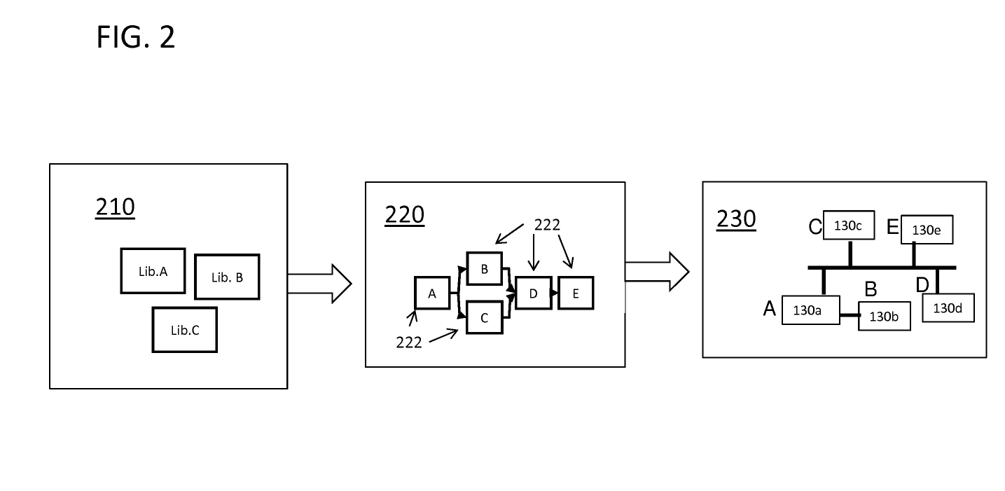

FIG. 1 is a block diagram of a hybrid system 100 according to an embodiment. The exemplary hybrid system 100 of FIG. 1 may be, for example, a super computer. Exemplary hybrid systems 100 include IBM systems such as the Roadrunner, System S, BlueGene, Pegasus, zGryphon, and PRISM. The hybrid system 100 includes a memory device 110, an end user device 120 or interface, any number of resources 130, and a compiler 140 that all communicate over a network 150. Alternate embodiments of the hybrid system 100 may include one or more data busses as well as more than one network 150 over which the various parts of the hybrid system 100 communicate. The memory device 110 may store libraries (210 shown at FIG. 2) of sub-programs developed by library developers that the end user uses as components (222 of FIG. 2) to create applications. The memory device 110 may be a collection of storage units. The end user device 120 may include the display and input interface needed for a user to access the resources 130 of the hybrid system 100. In alternate embodiments, the end user device 120 may be separate from the exemplary super computer hybrid system 100. For example, the end user device 120 may be a computer communicating over a network or one or more busses with a super computer that includes the resources 130 of the hybrid system 100. The resources 130 of the hybrid system 100 are the different processors. Resources 130 can be of different types, such as central processing unit (CPU) or graphics processing unit (GPU), for example. The compiler 140 compiles the application code generated by end users using the libraries 210 and assigns the resources 130 as detailed below.

FIG. 2 is a functional block diagram according to an embodiment. Developers create libraries 210 of optimized reusable sub-programs (components 222). These components 222 may be generated using special acceleration hardware, single instruction multiple data (SIMD) instructions, loop unrolling and the like, based on the particular hardware architectures of the hybrid system 100. As noted with reference to FIG. 1, the libraries 210 may be stored in the memory device 110 of the hybrid system 100. End users, who are programmers creating applications, obtain components 222 from the libraries 210 and combine them in a stream graph 220 such that an application is written as a stream flow. The compiler 140 compiles the application code generated as the stream graph 220 of components 222 from the libraries 210 and generates a resource assignment 230 to process the components 222 of the stream graph 220.

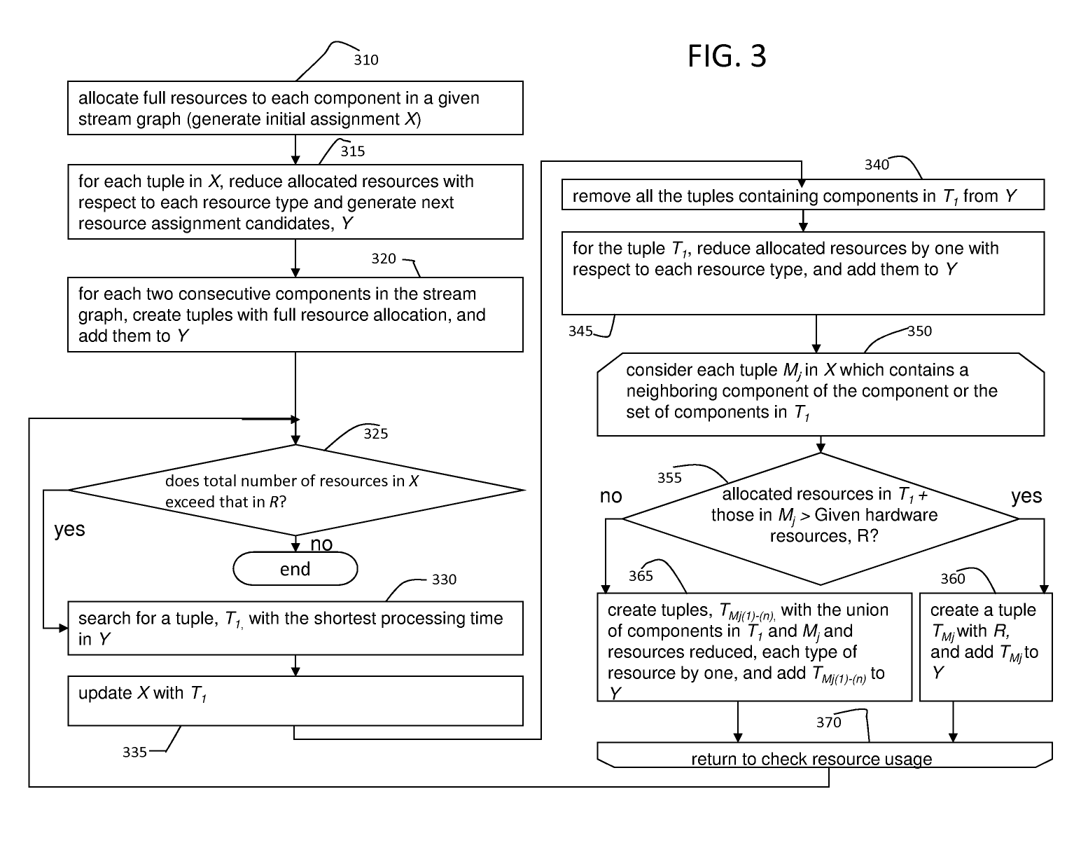

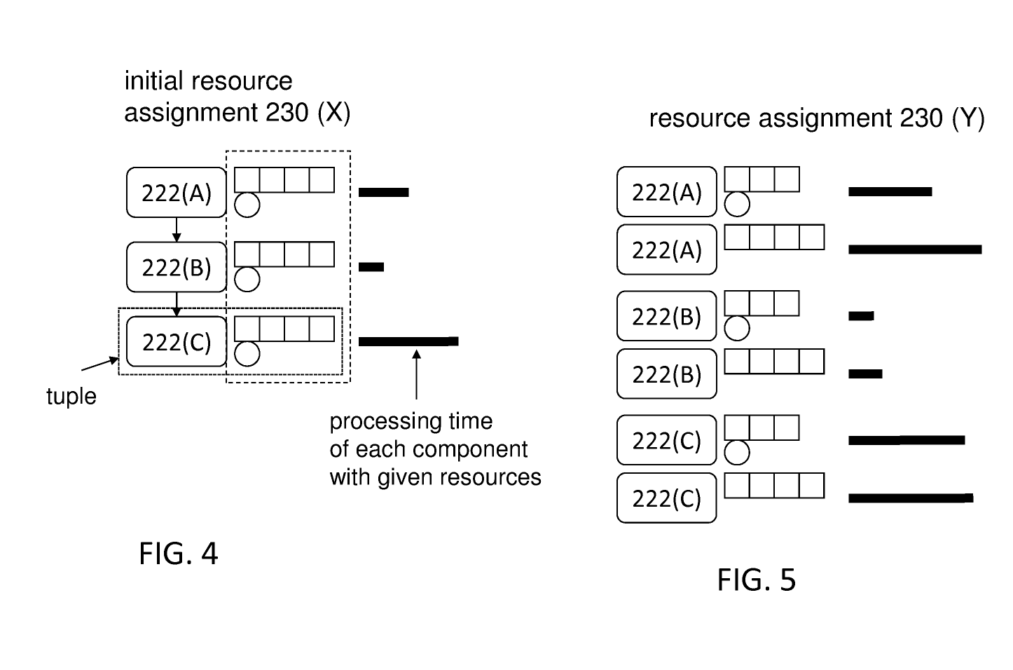

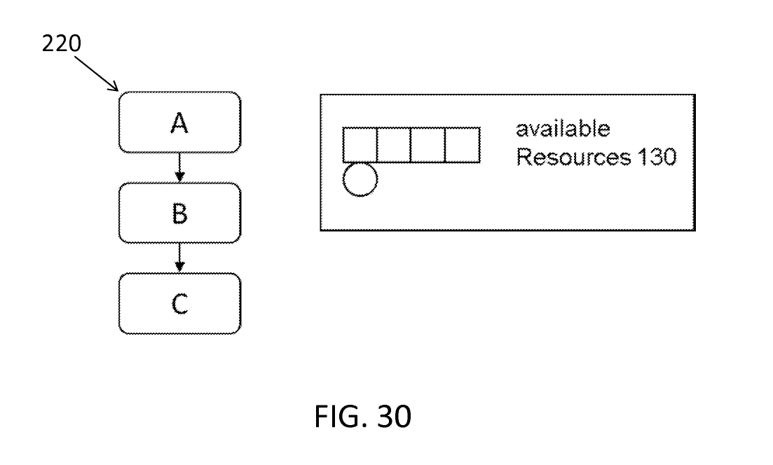

FIG. 3 is a flow diagram of a resource assignment process according to an embodiment. The process is performed by the compiler 140 in generating the resource assignment 230 based on the stream graph 220 created by an end user. Several of the blocks in the process are illustrated by FIGS. 4-27. For FIG. 4-27, a resource 130 of type CPU is indicated by a square while a resource 130 of type GPU is indicated by a circle. The exemplary stream graph 220 used for FIGS. 4-27 has components 222 (sub programs) indicated by A, B, and C and has available resources 130 of four CPUs and one GPU, as shown in FIG. 30.

At 310, the process includes allocating full (all available) resources 130 to each component 222 of the stream graph 220 to generate an initial resource assignment 230 X, as shown by FIG. 4. At block 315, for each tuple (component 222 and corresponding resource(s) 130), the process includes reducing the initially allocated resources 130 with respect to each resource 130 type to create another resource assignment 230 Y, as shown at FIG. 5. That is, the first component 222 A shown at FIG. 5 has a CPU type resource 130 reduced from its initial resource assignment 230 in X (shown at FIG. 4), while the second component 222 A shown at FIG. 5 has a GPU type resource 130 reduced from its initial resource assignment 230 in X. This same reduction is shown for components 222 B and C, as well.

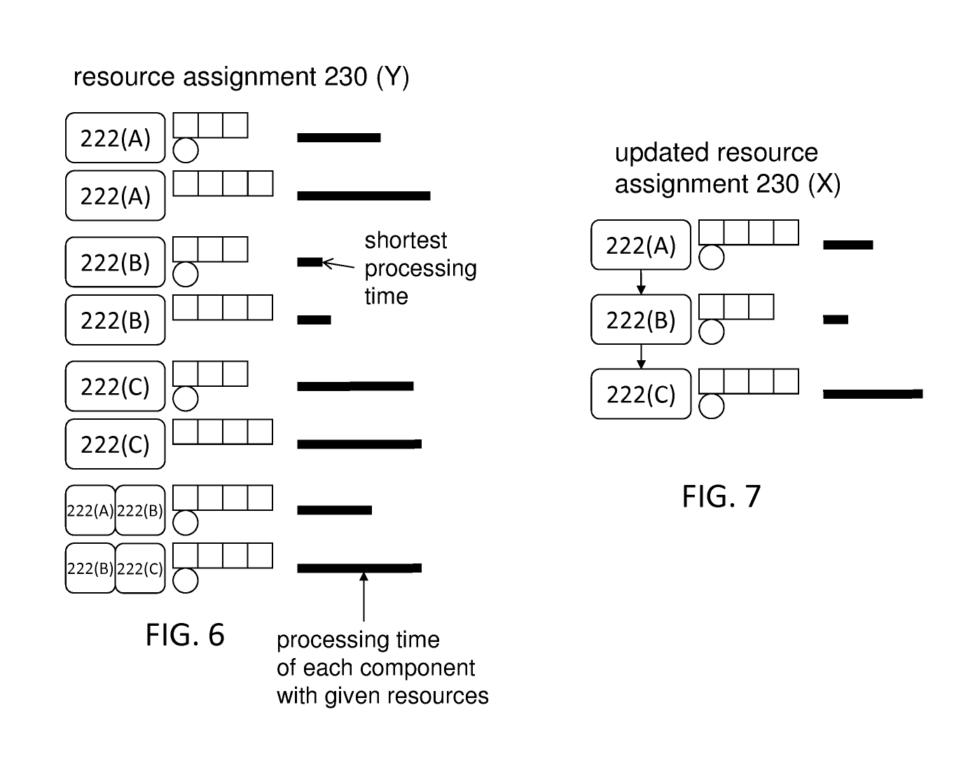

At block 320, tuples are created for every pair of two consecutive components 222 in the stream graph 220, the full resources 130 are allocated to each of the created tuples, and the tuples are added to resource assignment 230 Y, as shown at FIG. 6. As shown, in the exemplary case with a stream graph 220 including AB C, two tuples are created: one for the pair of consecutive components 222 A and B, and one for the pair of consecutive components 222 B and C. At decision block 325, the process includes checking to see whether the number of resources 130 in resource assignment 230 X exceeds the number of available resources 130 (R). It should be clear that, because the initial resource assignment 230 X (shown in FIG. 4, for example) allots every available resource to each component 222 of the stream graph 220, the initial resource assignment 230 X cannot pass this check. Assuming the total number of resources 130 in resource assignment 230 X exceeds the number of available resources 130 (R), the process proceeds to block 330 to search for the tuple (T₁) with the shortest processing time in resource assignment 230 Y (FIG. 6). As shown by FIG. 6, the first component 222 B (assigned three CPUs and one GPU) has the shortest processing time in the example. Thus, for the exemplary stream graph 220, the tuple T₁ is associated with component 222 B. At block 335, resource assignment 230 X is updated with T₁, the tuple in resource assignment 230 Y that has the shortest processing time. The resulting updated resource assignment 230 X is shown at FIG. 7.

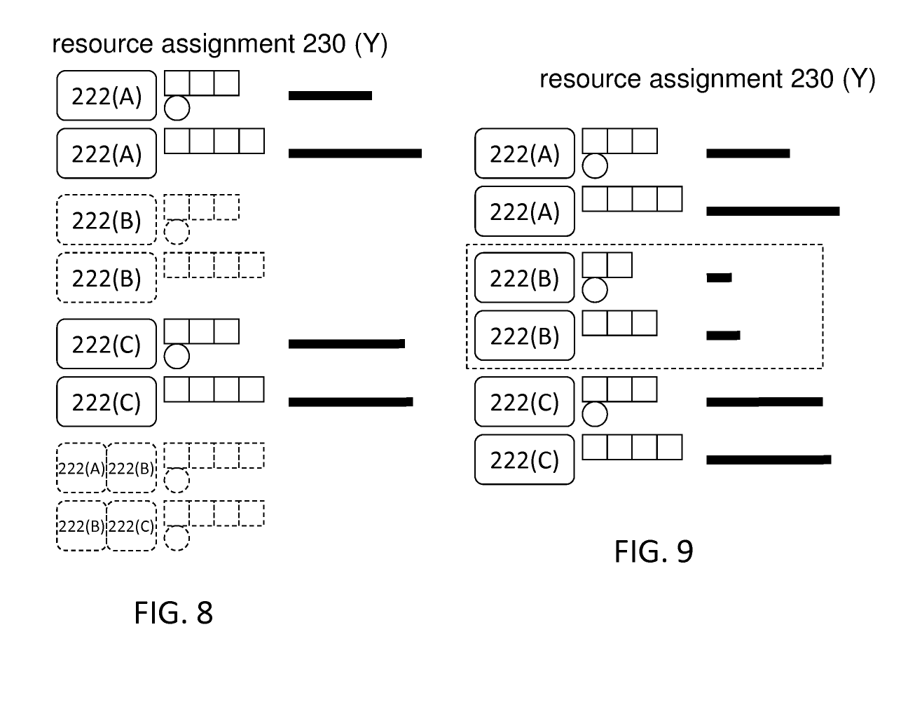

Proceeding to block 340, the process includes removing all the tuples from resource assignment 230 Y that include the component 222 used to generate tuple T₁. In the example illustrated by FIG. 6, the component 222 associated with the tuple with the shortest processing time (used to generate T₁) is B. Thus, as shown at FIG. 8 by the dashed-line tuples, all those tuples including component 222 B are removed from resource assignment 230 Y (of FIG. 6) to generate a further modified resource assignment 230 Y. At block 345, the process includes reducing the allocated resources 130 for tuple T₁ with respect to each resource 130 type and adding that tuple T₁ (with reduced resources 130) to Y (of FIG. 8). As shown at FIG. 9, the exemplary tuple T₁ comprised of component 222 B (with three CPUs and one GPU assigned as shown at FIG. 6) is reduced, first by one CPU and next by the one GPU, as shown within the dashed rectangle. As shown at FIG. 9, the two generated tuples with reduced resources 130 are then added to the resource assignment 230 Y shown by FIG. 8.

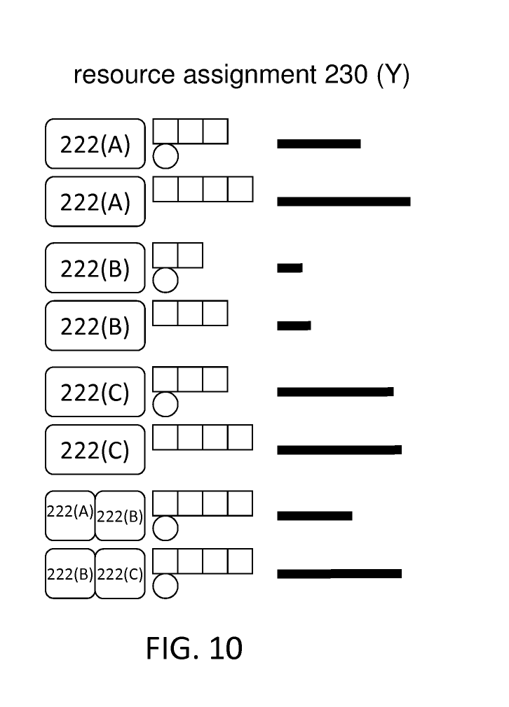

At block 350, the process includes considering each tuple (Mⱼ) in resource assignment 230 X that has a neighboring component 222 that is part of the tuple T₁ or a neighboring component 222 that is part of the set of components of the tuple T₁. For the exemplary stream graph 220 with the exemplary tuple T₁ including component 222 B, as discussed above, the tuples Mⱼ include components 222 A and C, because each of those components 222 is a neighboring component of the component 222 (B) in the tuple T₁. At decision block 355, the process includes checking whether the allocated resources 130 in the tuple T₁ added with those in Mⱼ exceed the available resources 130, R. If they do, the process proceeds to block 360, at which a tuple _{Mj} (a tuple created by a union of components in T₁ and Mⱼ) is created with all the available resources 130, R and the tuple T_{Mj} is added to Y, as shown at FIG. 10. In the exemplary case discussed above, the tuples T_{Mj} would include components 222 A and C. If the allocated resources 130 in the tuple T₁ added with those in Mⱼ do not exceed the available resources 130, R, then the process proceeds to block 365. At block 365, tuples T_{Mj(1)-(n)} are created with the union of components 222 in tuple T1 (component 222 B in the exemplary case) and tuples Mj (components 222 A and C in the exemplary case). The resources 130 of the created tuples T_{Mj(1)-(n)} are reduced with respect to each type of resource 130 and added to the resource assignment 230 Y. Regardless of whether block 360 or block 365 is reached, at block 370, the process returns to block 325 until the outcome of the check at block 325 is that the total number of resources 130 in the resource assignment 230 X does not exceed the available resources 130, R.

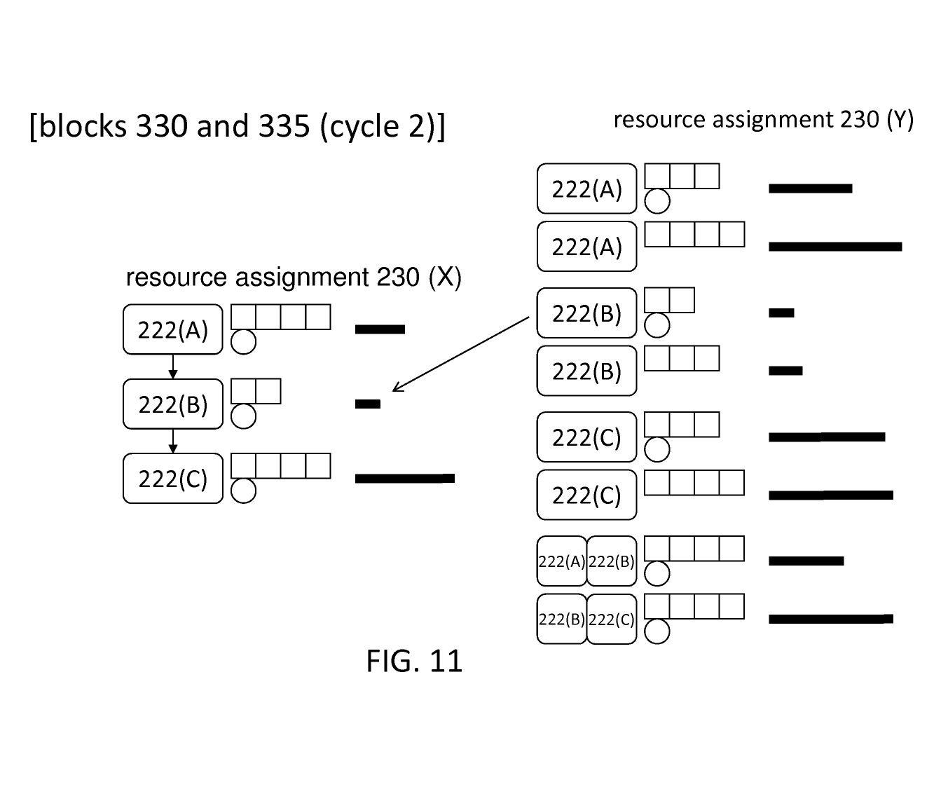

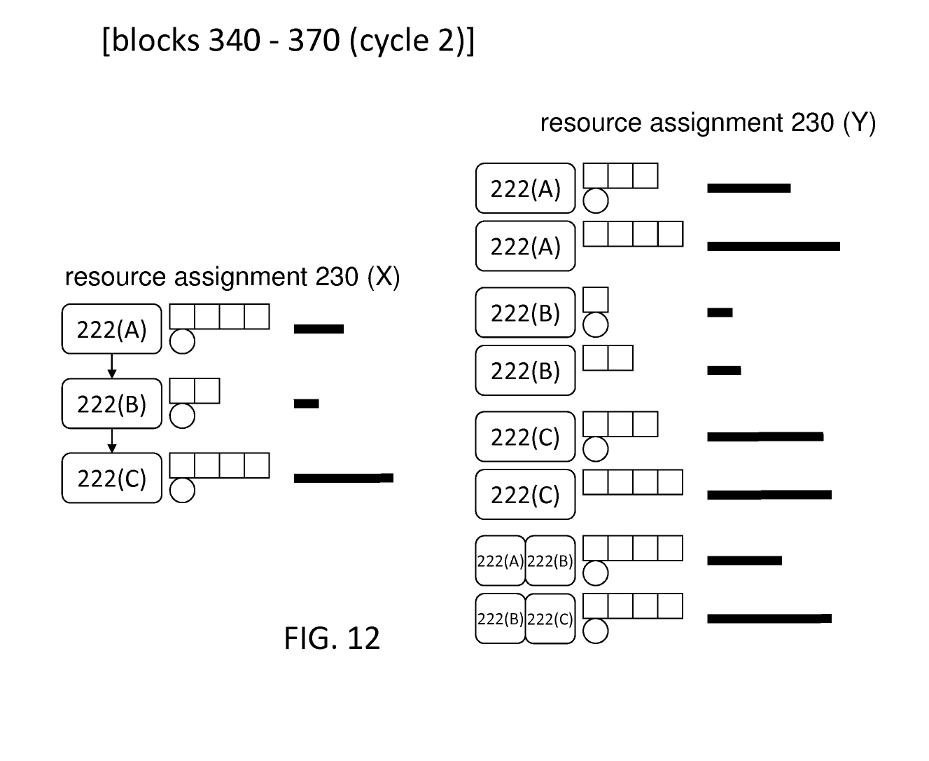

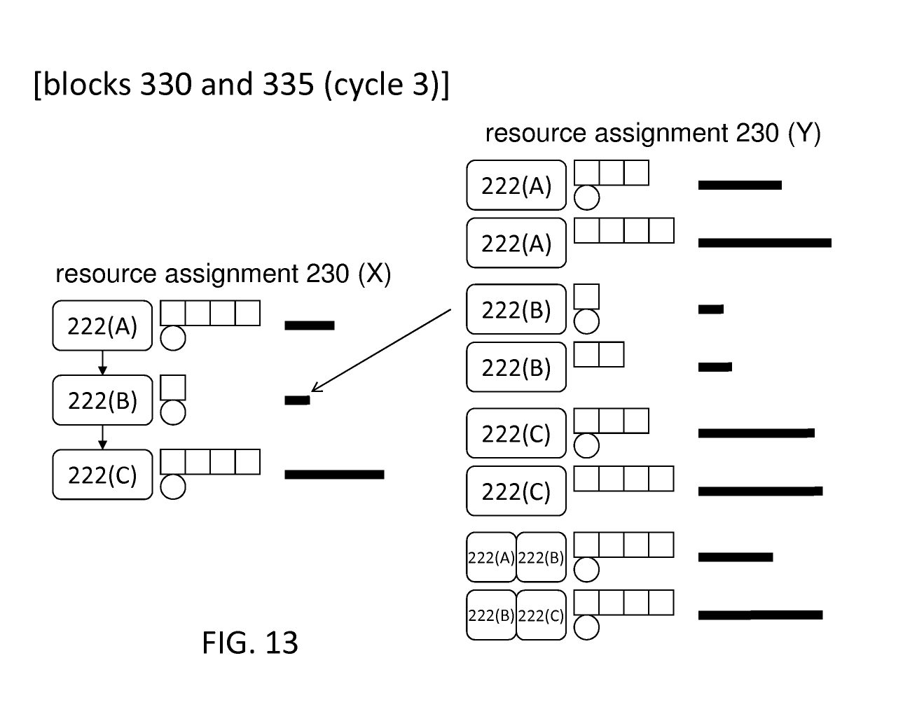

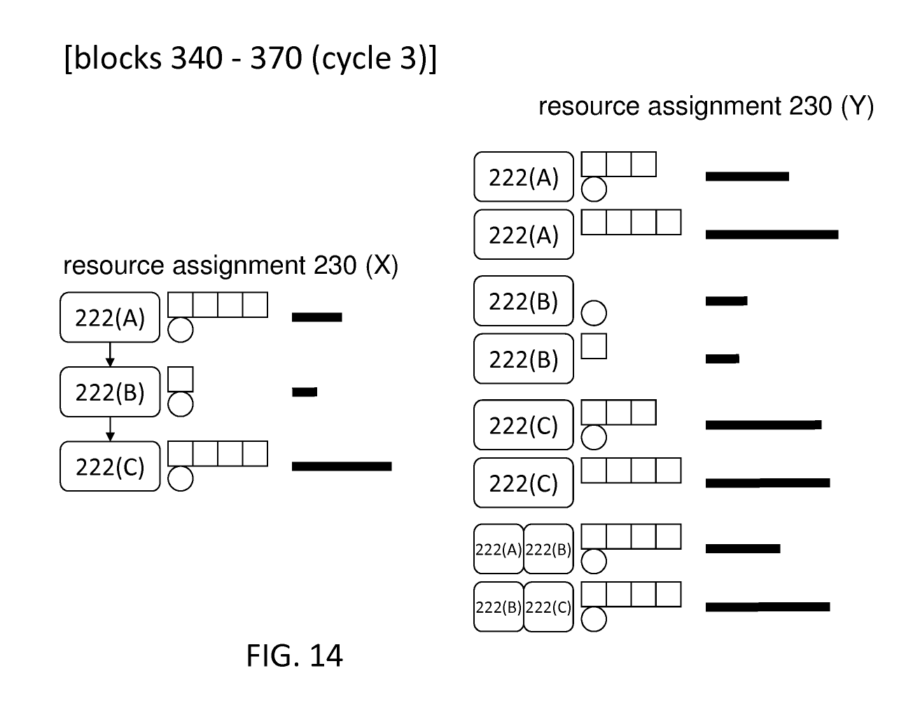

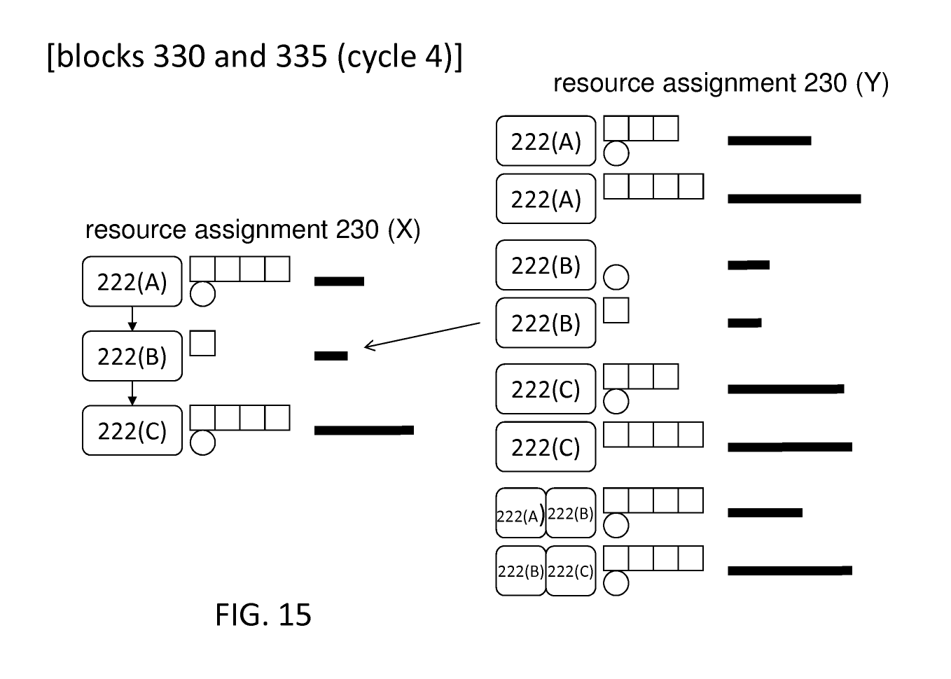

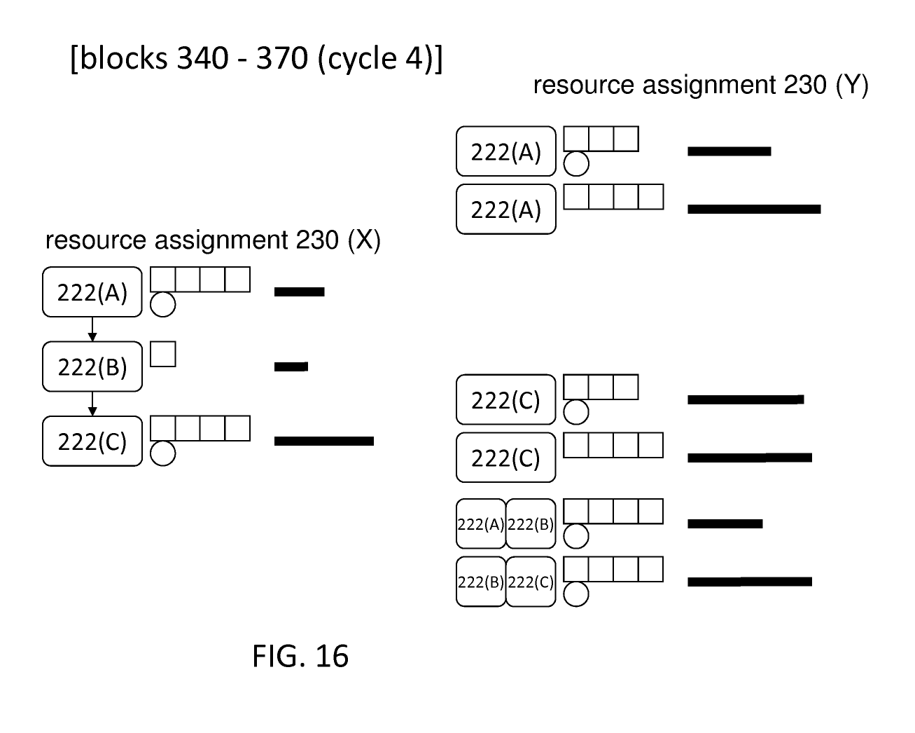

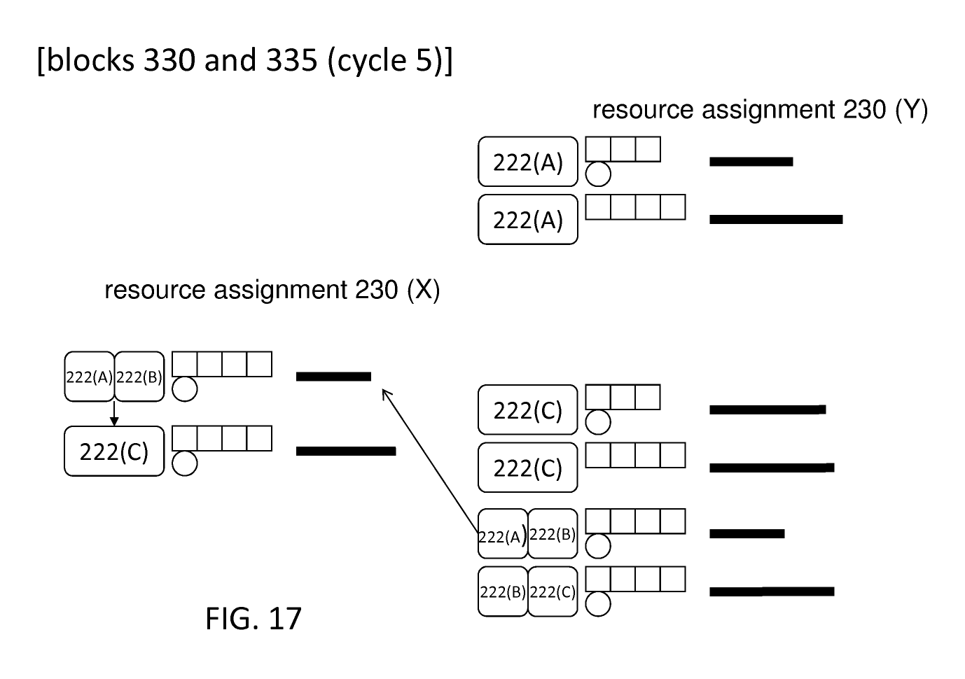

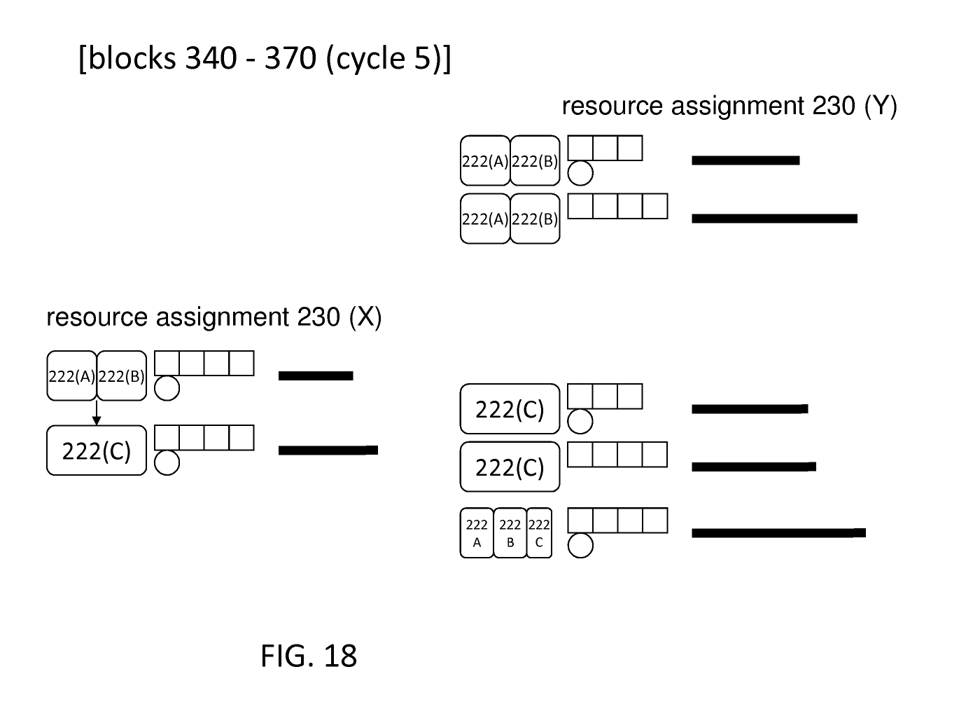

FIGS. 11-27 illustrate the iterations used to end the process for the exemplary stream flow 220 comprising components ABC. FIG. 11 shows resource assignments 230 X and Y for the second iteration of blocks 330 and 335, and FIG. 12 shows resource assignments 230 X and Y for the second iteration of blocks 340 through 370. FIG. 13 shows resource assignments 230 X and Y for the third iteration of blocks 330 and 335, and FIG. 14 shows resource assignments 230 X and Y for the third iteration of blocks 340 through 370. FIG. 15 shows resource assignments 230 X and Y for the fourth iteration of blocks 330 and 335, and FIG. 16 shows resource assignments 230 X and Y for the fourth iteration of blocks 340 through 370. FIG. 17 shows resource assignments 230 X and Y for the fifth iteration of blocks 330 and 335, and FIG. 18 shows resource assignments 230 X and Y for the fifth iteration of blocks 340 through 370. FIG. 17 illustrates the first instance in the assignment X that includes a sharing of resources 130 among components. That is, one of the key features of the process described herein is the sharing of the same resource 130 by two or more components 222 of a stream graph 220. Prior resource assignment techniques have required that each component is assigned to one or more separate resources 130.

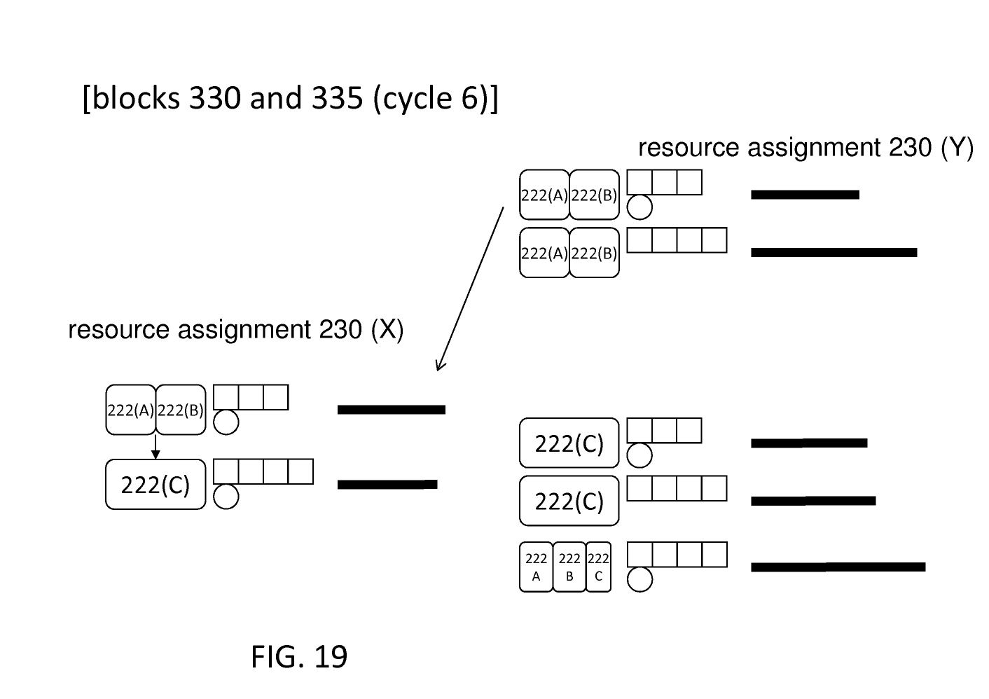

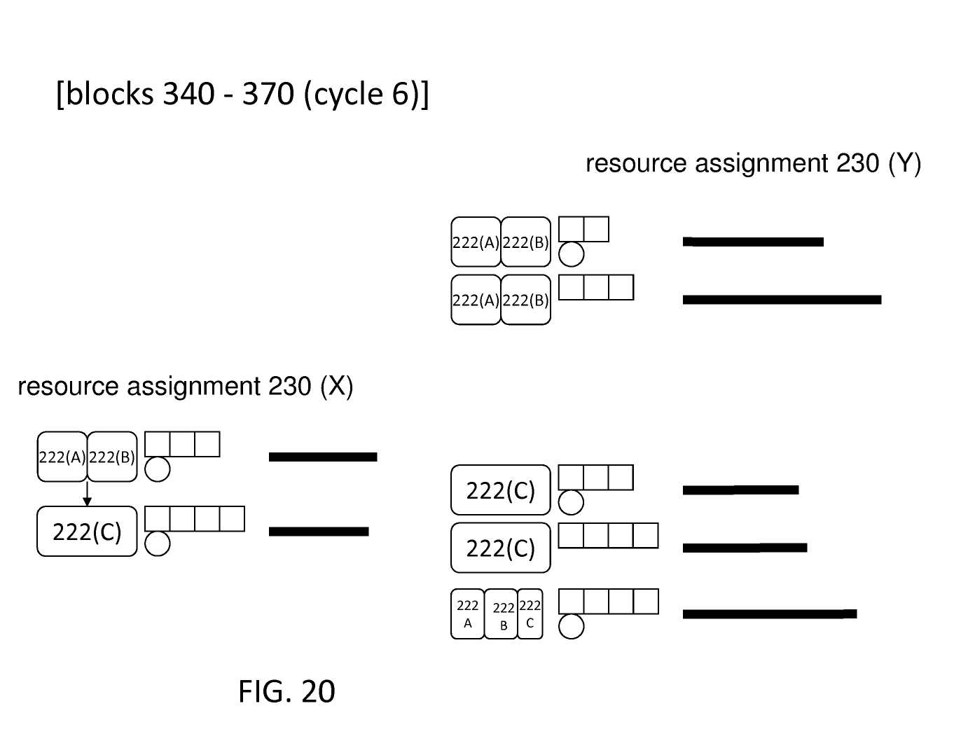

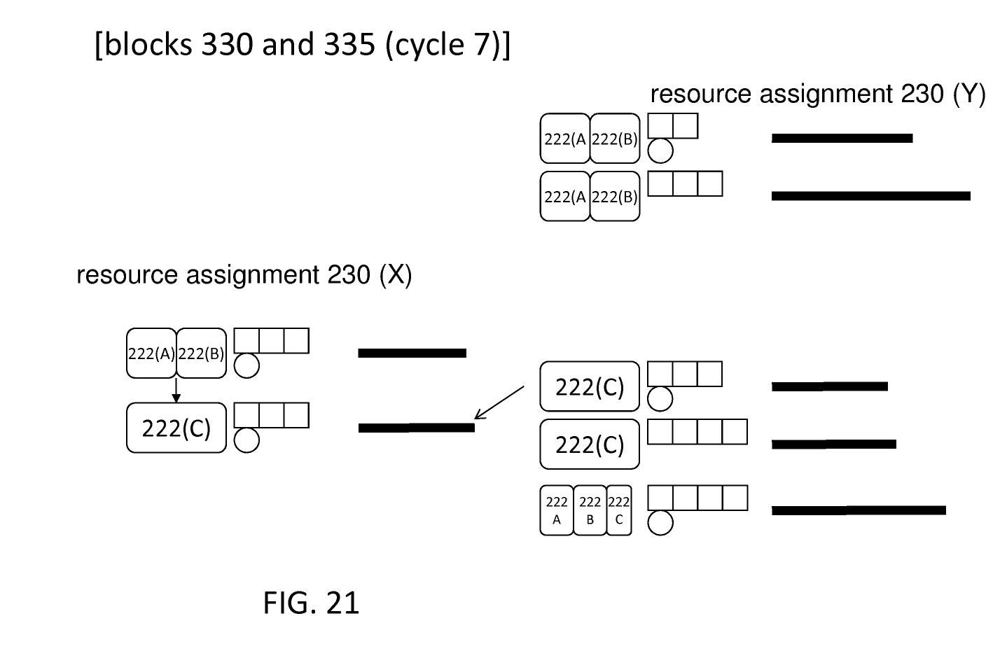

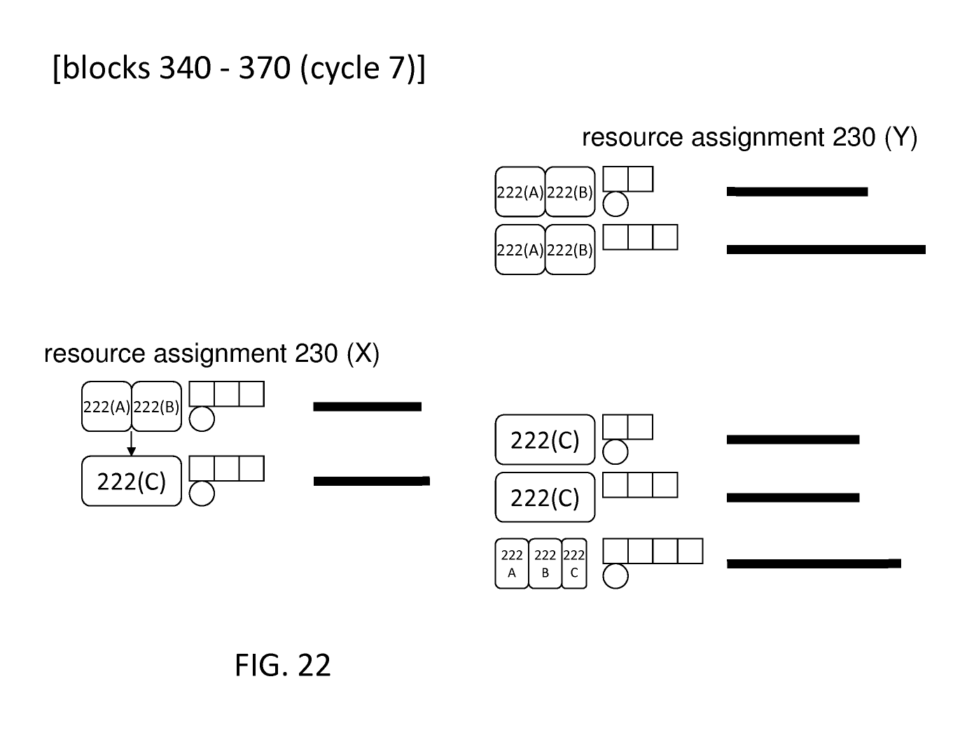

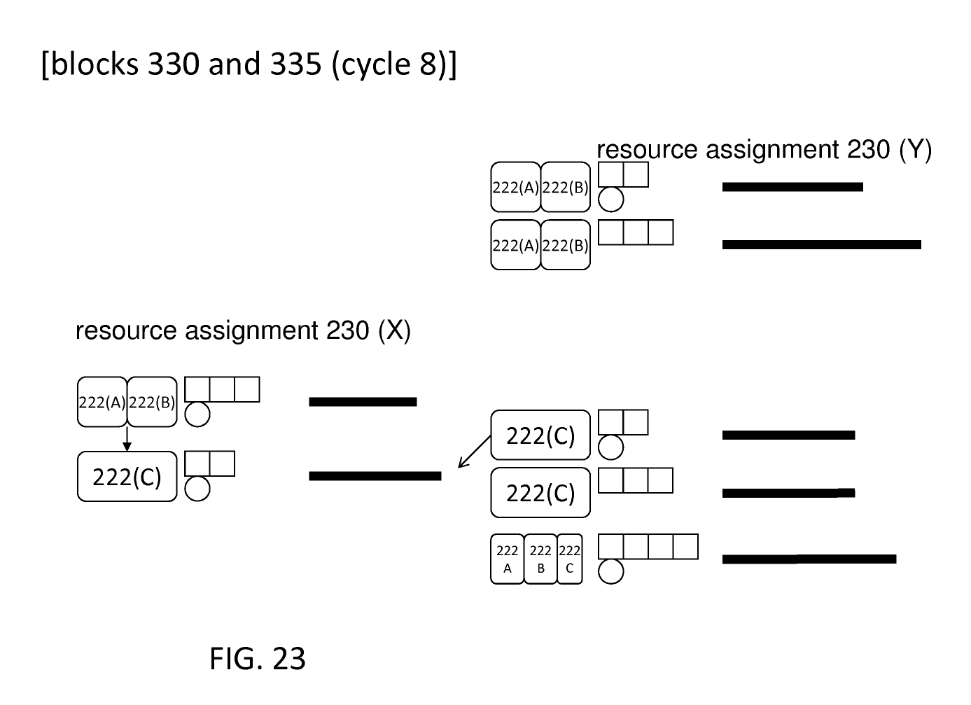

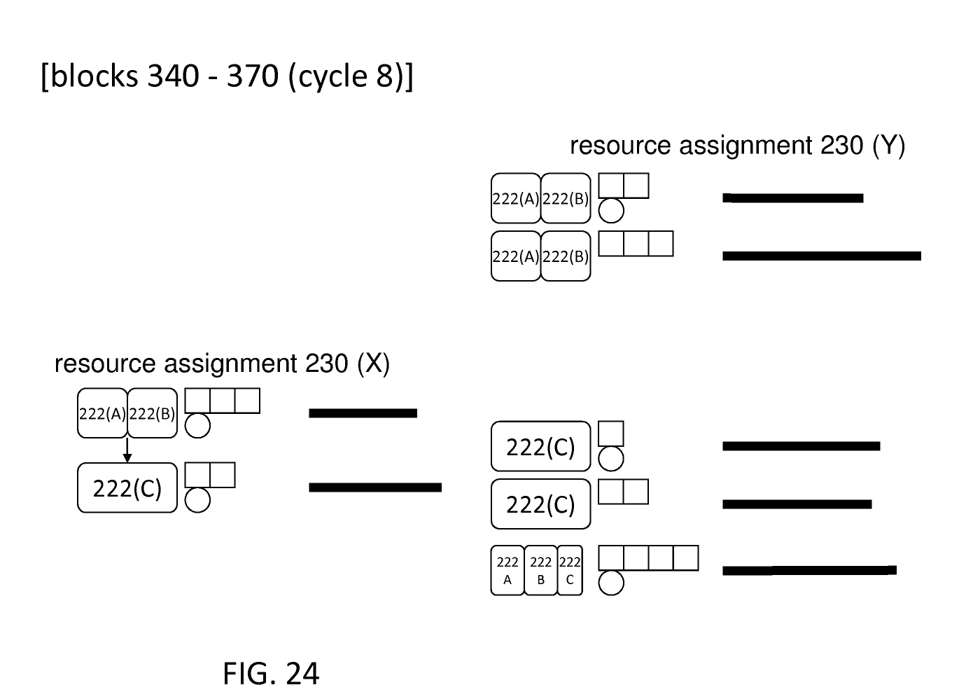

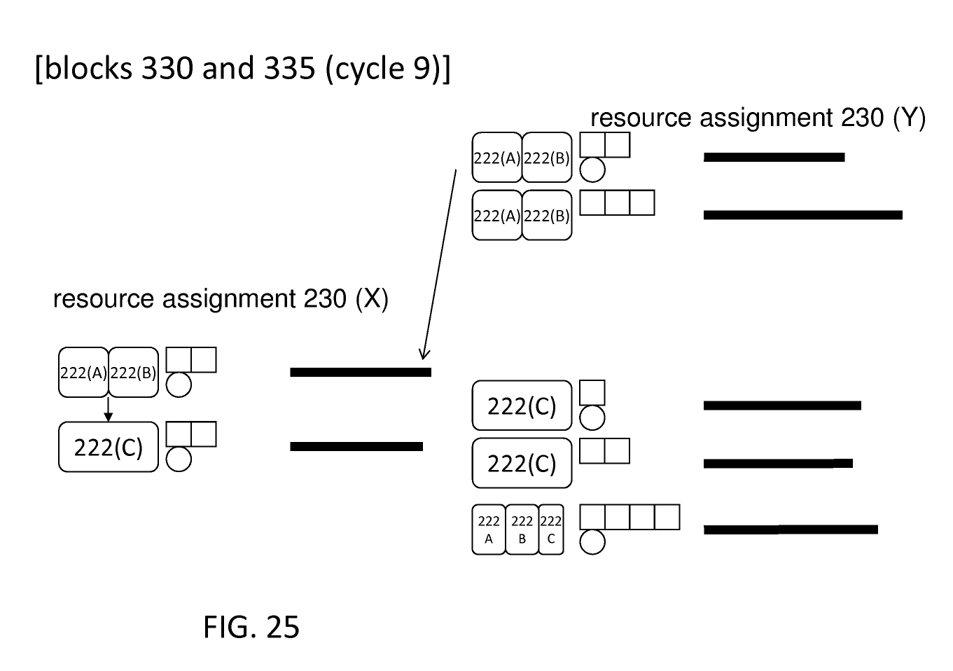

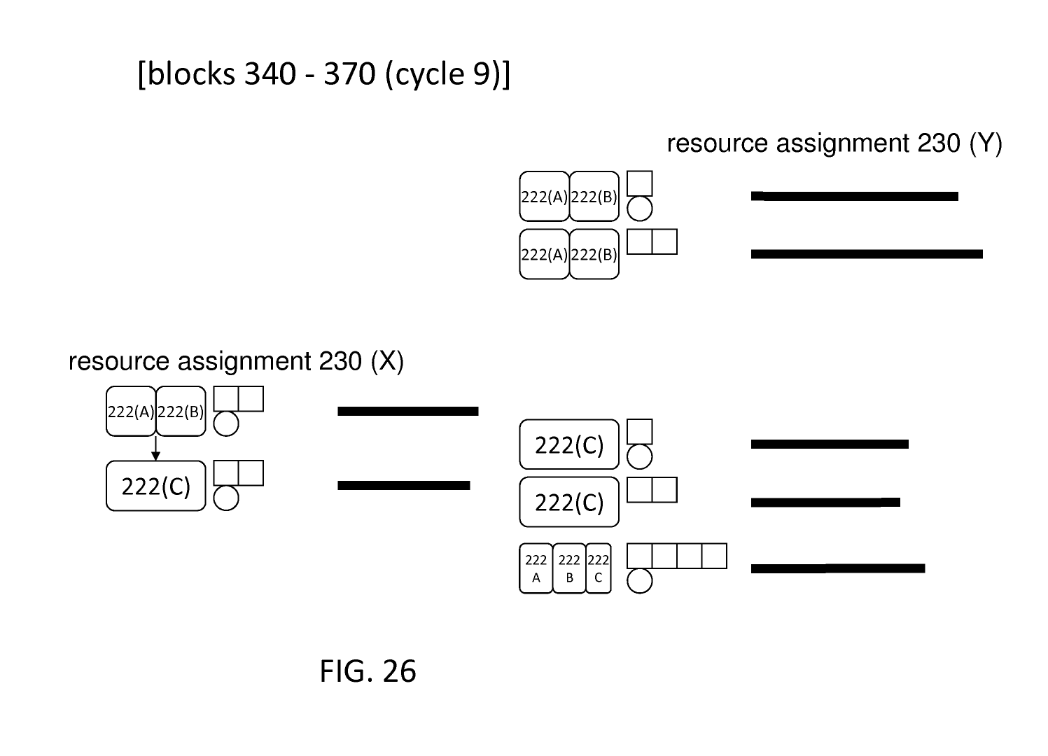

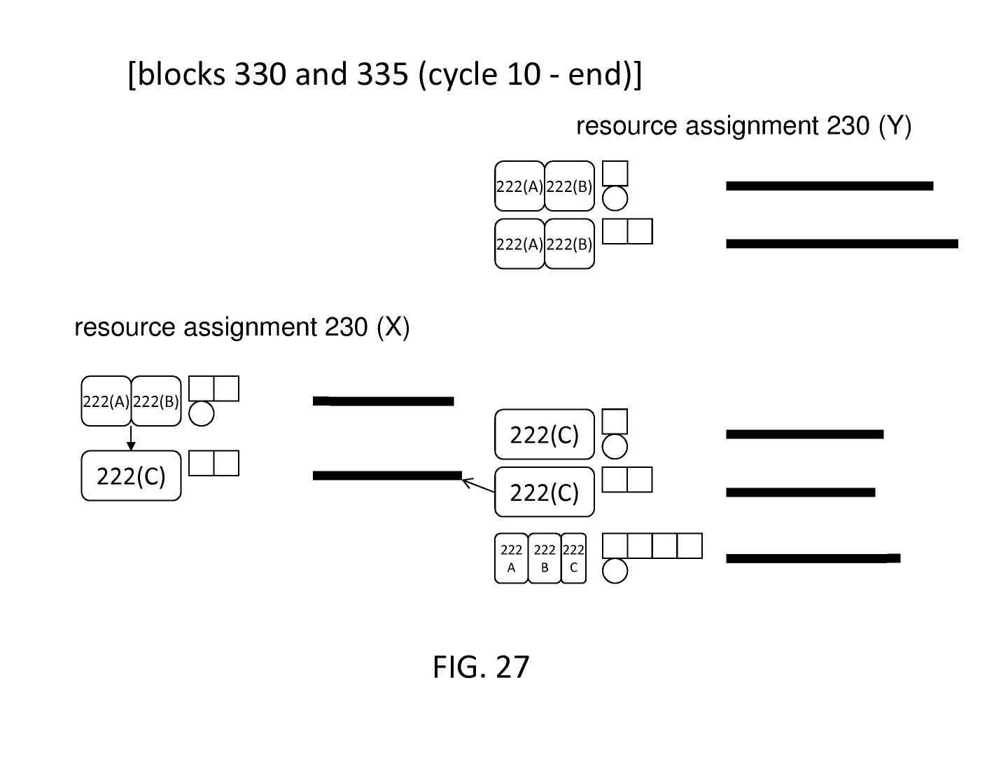

FIG. 19 shows resource assignments 230 X and Y for the sixth iteration of blocks 330 and 335, and FIG. 20 shows resource assignments 230 X and Y for the sixth iteration of blocks 340 through 370. FIG. 21 shows resource assignments 230 X and Y for the seventh iteration of blocks 330 and 335, and FIG. 22 shows resource assignments 230 X and Y for the seventh iteration of blocks 340 through 370. FIG. 23 shows resource assignments 230 X and Y for the eighth iteration of blocks 330 and 335, and FIG. 24 shows resource assignments 230 X and Y for the eighth iteration of blocks 340 through 370. FIG. 25 shows resource assignments 230 X and Y for the ninth iteration of blocks 330 and 335, and FIG. 26 shows resource assignments 230 X and Y for the ninth iteration of blocks 340 through 370. FIG. 27 shows resource assignments 230 X and Y for the tenth and final iteration of blocks 330 and 335. As FIG. 27 shows, the total number of resources 130 needed for the resource assignment 230 X is four CPUs and one GPU, which is the available resources 130 R in the exemplary hybrid system 100.

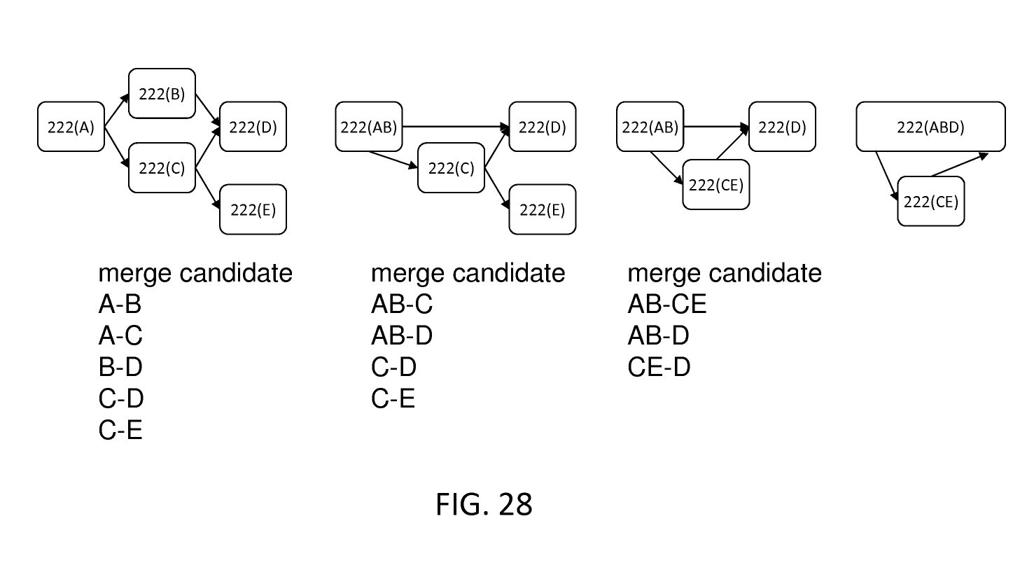

FIG. 28 illustrates component merging according to an embodiment. Any two components 222 connected by an edge may be merged. Merging the components 222 represents sharing the same resource 130 or resources 130 among the merged components 222. In previous compilation processes, each resource could only host one parallelized component 222 and each component 222 occupied at least one resource 130 by itself, regardless of how short the processing time for that component 222. By merging components 222 and sharing resources 130, according to the embodiments described above, to generate the resource assignment 230, pipeline bubbles can be reduced or eliminated, thereby increasing throughput.

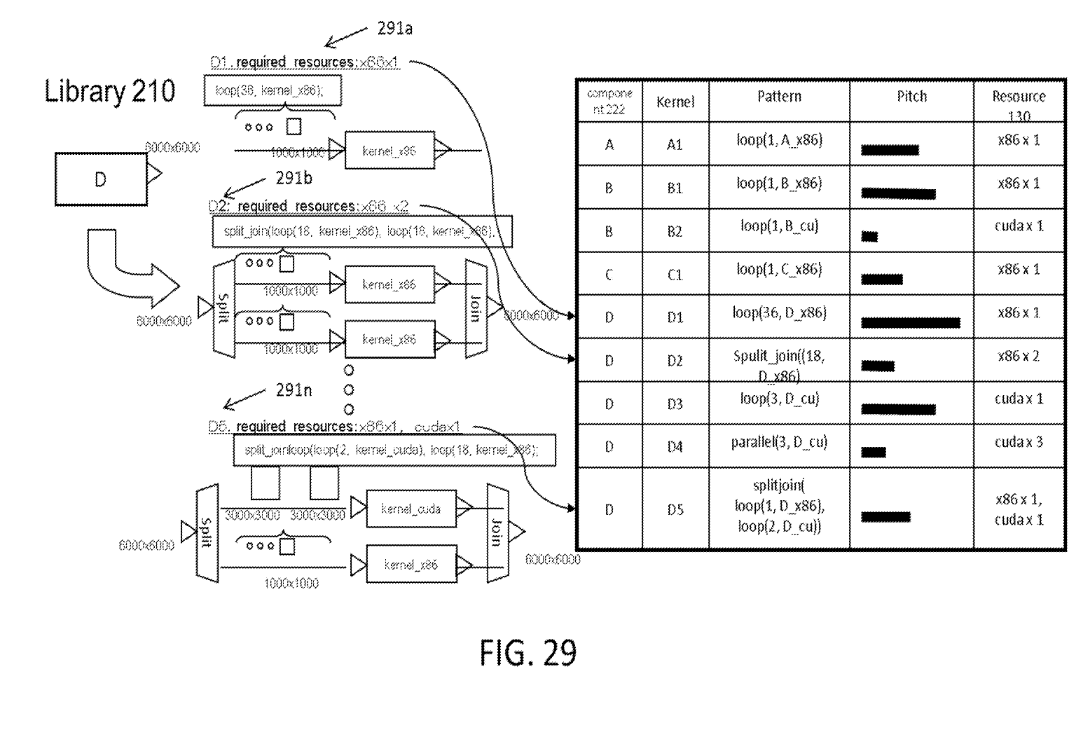

FIG. 29 illustrates a process according to another embodiment. According to this embodiment, the compiler 140 may work in two phases. In a first phase, prior to compilation of a stream graph 220, several variations of the execution pattern 291 for a library 210 are automatically and incrementally generated. An execution pattern 291 details the behavior of components 222 to process a data set. In the example shown at FIG. 29, several execution patterns 291a-291n are shown for component 222 D. Because each component 222 of a given resource assignment 230 may be associated with multiple execution patterns 291, a resource assignment 230 is associated with multiple execution patterns 291. The generation of the execution patterns 291 may be done by existing compiler-optimization techniques, for example. The execution results for a given execution pattern 291 using the resources 130 of a given hybrid system 100 are registered. The results may be registered in an optimal execution pattern 291 table, for example. Better execution patterns 291 with better pipeline pitch may be searched by increasing resources 130, changing architecture of one or more resources 130 or both. During the first phase, processing time for each resource assignment 230 (X and Y) for each execution pattern 291 is examined so that the fastest execution pattern 291 may be determined and used. In the second phase, during stream graph 220 compilation, the compiler resolves the optimal execution pattern 291 for the given stream graph 220 using the given resources 130 by referring to the optimal execution pattern 291 table generated in the first phase. The execution pattern 291 may then be adjusted by gradually reducing resources 130 as shown at FIGS. 11-27. That is, the processing times shown at FIGS. 4 and 5, for example, are based on the execution pattern 291 used.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, blocks, operations, elements, and/or components, but do not preclude the presence or addition of one more other features, integers, blocks, operations, element components, and/or groups thereof.

The flow diagrams depicted herein are just one example. There may be many variations to this diagram or the blocks (or operations) described therein without departing from the spirit of the invention. For instance, the blocks may be performed in a differing order or blocks may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method of processing an application in a hybrid system comprising a plurality of resources, architecture of at least one of the plurality of resources being different from architecture of another of the plurality of resources, the method comprising:
storing libraries of sub-program components, two or more of the components being combined by an end user to generate the application as a stream flow; and
a compiler generating a resource assignment assigning the plurality of resources to process the two or more of the components in the stream flow, at least two of the two or more of the components in the stream flow sharing at least one of the plurality of resources according to the resource assignment.

2. The method according to claim 1, wherein the compiler generating the resource assignment includes the compiler performing an iterative process.

3. The method according to claim 2, wherein the iterative process includes merging the two or more of the components in the stream flow to share one or more of the plurality of resources.

4. The method according to claim 3, wherein the merging includes identifying components that have edges connected in the stream flow.

5. The method according to claim 2, wherein the iterative process begins with the compiler assigning the plurality of resources to each of the two or more of the components in the stream flow as an initial resource assignment and, based on a processing time of each of the two or more of the components in the stream flow, reducing the initial resource assignment.

6. The method according to claim 5, wherein the reducing the initial resource assignment includes merging two or more of the two or more of the components in the stream flow to use a same one of the plurality of resources.

7. The method according to claim 5, wherein the iterative process includes, in each iterative loop, identifying a component or combination of components assigned to each of the plurality of resources in a preceding iterative loop that has a shortest processing time.

8. The method according to claim 1, wherein the compiler generating the resource assignment is a two-phase process, a first phase of the two phases including generating execution patterns associated with each of the components and a second phase of the two phases including generating the resource assignment for the stream flow of the two or more of the components based on corresponding execution patterns.

9. The method according to claim 8, wherein the generating execution patterns in the first phase includes determining a processing time for each execution pattern of each of the components.

10. The method according to claim 9, wherein the generating execution patterns in the first phase further includes generating an optimal execution pattern table based on the processing time for each execution pattern of each of the components.

11. The method according to claim 10, wherein the generating the resource assignment in the second phase includes selecting an execution pattern for each of the two or more of the components in the stream flow based on the optimal execution pattern table.

12. A non-transitory computer program product for processing an application in a hybrid system comprising a plurality of resources, architecture of at least one of the plurality of resources being different from architecture of another of the plurality of resources, the computer program product comprising a storage medium including computer-readable program code which, when executed by a processor, causes the processor to implement a method, the method comprising:
generating an initial resource assignment assigning the plurality of resources to process each of two or more components in the stream flow defining the application; and
when a number of resources in the initial resource assignment exceeds a number of the plurality of resources available in the hybrid system, generating a final resource assignment, from the initial resource assignment, assigning the plurality of resources to process the two or more of the components in the stream flow, at least two of the two or more of the components in the stream flow sharing at least one of the plurality of resources according to the final resource assignment.

13. The method according to claim 12, the generating the final resource assignment is an iterative process.

14. The method according to claim 13, wherein the iterative process includes merging the two or more of the components in the stream flow to share one or more of the plurality of resources.

15. The method according to claim 14, wherein the merging includes identifying components that have edges connected in the stream flow.

16. The method according to claim 13, wherein the iterative process begins with assigning the plurality of resources to each of the two or more of the components in the stream flow as an initial resource assignment and, based on a processing time of each of the two or more of the components in the stream flow, reducing the initial resource assignment.

17. The method according to claim 16, wherein the reducing the initial resource assignment includes merging two or more of the two or more of the components in the stream flow to use a same one of the plurality of resources.

18. The method according to claim 16, wherein the iterative process includes, in each iterative loop, identifying a component or combination of components assigned to each of the plurality of resources in a preceding iterative loop that has a shortest processing time.

19. The method according to claim 12, wherein the generating the resource assignment is a two-phase process, a first phase of the two phases including generating execution patterns associated with each of the components and a second phase of the two phases including generating the resource assignment for the stream flow of the two or more of the components based on corresponding execution patterns.

20. The method according to claim 19, wherein the generating execution patterns in the first phase includes determining a processing time for each execution pattern of each of the components.

21. The method according to claim 20, wherein the generating execution patterns in the first phase further includes generating an optimal execution pattern table based on the processing time for each execution pattern of each of the components.

22. The method according to claim 21, wherein the generating the resource assignment in the second phase includes selecting an execution pattern for each of the two or more of the components in the stream flow based on the optimal execution pattern table.
